(19) United States
(12) Patent Application Publication
(10) Pub. No.: US 2013/0069939 A1
(43) Pub. Date: Mar. 21, 2013

(54) CHARACTER IMAGE PROCESSING APPARATUS AND METHOD FOR FOOTSKATE CLEANUP IN REAL TIME ANIMATION

(71) Applicant: Man-Kyu SUNG, Daejeon-si (KR)

(72) Inventor: Man-Kyu SUNG, Daejeon-si (KR)

(73) Assignee: Electronics and Telecommunications Research Institute, Daejeon (KR)

(21) Appl. No.: 13/620,360

(22) Filed: Sep. 14, 2012

(30) Foreign Application Priority Data
Sep. 16, 2011 (KR) 10-2011-0093666

(51) Int. Cl. G06T 13/00; G06T 15/00

(52) U.S. Cl. 345/419

(57) ABSTRACT

Provided are an apparatus and method for cleaning up footskate in real-time character animation that is generated using a depth camera. According to an aspect, a character image processing apparatus determines, when a character image frame is received, whether a character's foot included in the character image frame reaches a predetermined ground; sets a first character image frame in which a character's foot reaches the predetermined ground as a reference constraint frame; and designates the character's foot position in the reference constraint frame as a reference foot position. Then, the character image processing apparatus extracts any constraint frames in which the character's foot has to reach the predetermined ground from among character image frames received sequentially following the reference constraint frame, and adjusts a posture of the character in each constraint frame based on the reference foot position.

### CROSS-REFERENCE TO RELATED APPLICATION

This application claims the benefit under 35 U.S.C. §119(a) of Korean Patent Application No. 10-2011-0093666, filed on Sep. 16, 2011, the entire disclosure of which is incorporated herein by reference for all purposes.

### BACKGROUND

1. Field

The following description relates to an apparatus and method for automatically compensating for footskate generated in character animation by processing depth images received from a depth camera.

2. Description of the Related Art

Depth images are acquired by imaging the distances between objects in a space where a sensor is placed. Sensors such as Kinetic provide a function for analyzing depth images through middle ware such as OpenNI (Open Natural Interaction) which is an open source project to calculate values regarding a user's position and the positions and orientations of joints. The function can calculate values regarding the positions and orientations of 15 joints in real time.

Technologies for compensating for the motion of a 3D character have been mainly used in a motion capture system. The motion capture system captures motion of a person with markers using 8 cameras or more in real time to recognize 3D positions of the markers, acid then maps the results of the recognition to a 3D character model. However, a 3D character to which motion data acquired through motion capture is mapped is often, when it is played, subject to a phenomenon of the character's feet do not reach the ground or shake although the character stands motionless. Also, motion synthesis technologies (for example, motion graph, motion blending) based on motion-captured data tend to damage the original physical characteristics of the motion-captured data. A representative example where the physical characteristics of motion-captured data are damaged is so-called “footskating”.

Footskating is one of factors that cause awkwardness in motion when human characters move in animation. The reason is because unnatural footskating can be easily recognized since humans tend to be sensitive to human motion.

The reason why such footskating occurs when Kinect is used to create character images for animation is as follows.

First, depth images themselves have errors. That is, Kinect is very sensitive to internal lighting since it utilizes an IR projector. Accordingly, extracted depth images are highly likely to contain errors.

Second, there may be errors in an algorithm for extracting joint positions and orientations of a skeleton that is provided through a Software Development Kit (SDK), etc. For example, XBOX of Microsoft estimates the positions and orientations of joints using a machine learning method, and OpenNI maps a depth image to a predetermined standard skeleton model so as to estimate the positions and orientations of joints. However, there are difficulties in obtaining accurate values with respect to all postures since occlusion is produced according to depth.

Meanwhile, a method for footskate cleanup for human characters using motion capture has been proposed in “Footskating Cleanup for Motion Capture Editing”, published in ACM 2002 Article by Kovar. However, since the method can be applied to an off-line method, not an on-line method, it is difficult to apply the method to characters who are played on-line in real time. If a motion capture method is used, a problem of footskating can be easily resolved using information about the previous and next frames of a current frame since data about all frames is given. However, if frames are received in real time, there are difficulties in solving the problem of footskating since no information about the next frame is given.

### SUMMARY

The following description relates to an apparatus and method capable of cleaning up footskating generated when real-time character animation is produced using a depth camera.

In one general aspect, there is provided a character image processing apparatus including: a constraint frame deciding unit configured to receive a character image frame, to determine whether a character's foot included in the character image frame reaches a predetermined ground, to set a first character image frame in which a character's foot reaches the predetermined ground as a reference constraint frame, and to designate the character's foot position in the reference constraint frame as a reference foot position; and a character posture adjusting unit configured to extract any constraint frames in which the character's foot has to reach the predetermined ground from among character image frames received sequentially following the reference constraint frame, and to adjust a posture of the character in each constraint frame based on the reference foot position.

In another general aspect, there is provided a character image processing method including: receiving a character image frame and determining whether a character's foot included in the character image frame reaches a predetermined ground; setting a first character image frame in which the character's foot reaches the predetermined ground as a reference constraint frame; designating the character's foot position in the reference constraint frame as a reference foot position; and extracting any constraint frames in which the character's foot has to reach the predetermined ground from among character image frames received sequentially following the reference constraint frame, and adjusting a posture of the character in each constraint frame based on the reference foot position.

Other features and aspects will be apparent from the following detailed description, the drawings, and the claims.

### BRIEF DESCRIPTION OF THE DRAWINGS

FIG. 1 is a diagram illustrating an example of a character image processing apparatus for cleaning up footskate in real-time character animation.

FIG. 2 is a diagram illustrating an example of a character image processor of the character image processing apparatus illustrated in FIG. 1.

FIG. 3 shows an example of constraint frame periods in which a character's foot reaches a ground.

FIG. 4 is a view for explaining an example of a method of adjusting the position of a root joint based on a character's one leg.

FIG. 5 is a view for explaining a method of adjusting the position of a root joint based on a character's two legs.

FIGS. 6A, 6B, and 6C are views for explaining an example where Inverse Kinematics (IK) is applied to adjust a character's posture.

FIG. 7 is a flowchart illustrating an example of a character image processing method.

FIG. 8 is a flowchart illustrating in detail an example of an operation of adjusting a character's posture.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

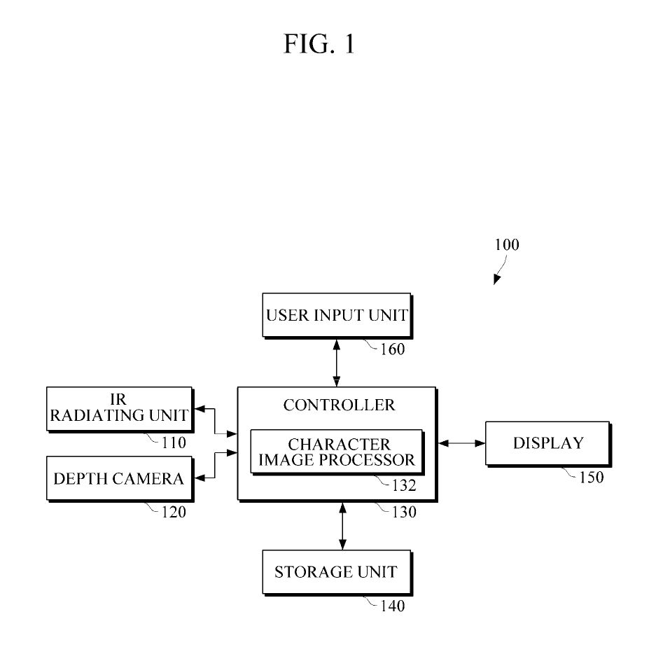

FIG. 1 is a diagram illustrating an example of a character image processing apparatus 100 for cleaning up footskate in real-time character animation.

Referring to FIG. 1, the character image processing apparatus 100 may include an Infrared (IR) radiating unit 110, a depth camera 120, a controller 130, a storage unit 140, a display 150, and a user input unit 160. The character image processing apparatus 100 may be implemented as one of various electronic machines, such as a personal computer, a portable camera, a television, a smart device, or a game.

The IR radiating unit 110 emits infrared radiation to an object such as a human.

The depth camera 120 captures infrared radiation reflected from the object to create a depth image frame. The depth image frame includes information regarding the distance between the object and the character image processing apparatus 100. The depth camera 120 may capture a moving object by sequentially photographing it, and transfer the captured result to the controller 130. For example, the depth camera 120 may transfer depth image frames at 30 frames/sec to the controller 130.

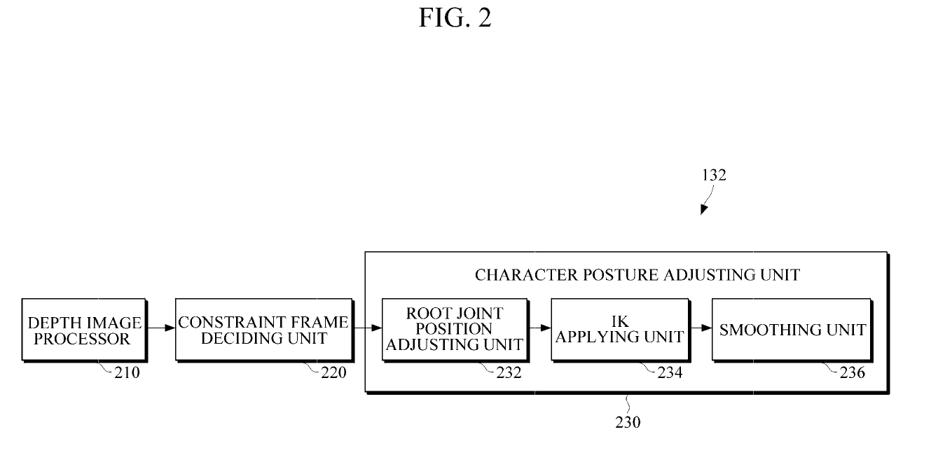

The character image processor 132 processes the depth image frames received from the depth camera 120 to create character image frames. In detail, the character image processor 132 analyzes the depth image frames to extract information about a plurality of joints of the object from the depth image frames, and maps the information about the plurality of joints of the object to the corresponding joints of a character, thereby creating character image frames. Also, the character image processor 132 is configured to process the character image frames so that footskate is cleaned up from character animation formed with the character image frames. Details about the configuration and operation of the character image processor 132 will be described with reference to FIG. 2, later.

The storage unit 140 may store an Operating System (OS) and various application data needed for operation of the character image processing apparatus 100, character image animation data processed by the processor 130, etc.

The display 150 outputs the character image frames processed by the character image processor 132. The display 150 may provide character animation by outputting a series of character image frames. Also, the display 150 may provide real-time character animation by sequentially displaying character images having character postures decided by the character image processor 132.

The user input unit 160 receives a user input signal and transfers it to the controller 130. The controller 130 may control the operation of the character image processor 132 based on the user input signal. The user input unit 160 may be a keyboard, a touch panel, a touch screen, a mouse, etc.

FIG. 2 is a diagram illustrating an example of the character image processor 132 of the character image processing apparatus 100 illustrated in FIG. 1.

Referring to FIG. 2, the character image processor 132 includes a depth image processor 210, a constraint frame deciding unit 220, and a character posture adjusting unit 230.

The depth image processor 210 may provide a function for analyzing depth image frames through middle ware such as OpenNI (Open Natural Interaction) which is an open source project to calculate values regarding a user's position and the positions and orientations of joints. Here, the orientation values of the joints may be expressed as Quaternions. For example, the depth image processor 210 may use the function to calculate values regarding the positions and orientations of 15 joints in real time. Also, the depth image processor 210 may load a 3D character, count the number of joints included in the 3D character, and designate names of the joints.

The depth image processor 210 may acquire, whenever receiving a depth image frame, a plurality of joints from the depth image frame, and map the joints to a plurality of corresponding joints of a 3D character to thereby create a character image frame from the depth image frame. Mapping the joints acquired from the depth image frame to the corresponding joints of the 3D character means setting the orientation value of each joint acquired from the depth image frame to the orientation value of the corresponding joint of the 3D character. As described above, the orientation values may be expressed as Quaternions. Accordingly, the created character image frame includes information about orientation values of the joints of the 3D character, and the information about orientation values of the joints, acquired as the results of processing on the depth image frame, are original orientation values of the joints.

The depth image processor 210 transfers the character image frame to the constraint frame deciding unit 220. The depth image processor 210 may process, whenever receiving a depth image, the depth image to create a character image frame, and transfer the character image frame to the constraint frame deciding unit 220.

According to characteristics of human motion, a human who has set his or her foot on the ground maintains his or her foot in contact with the ground for a specific time period. In walking motion, generally, each foot is set on the ground for about 1 or 2 seconds. “footskating” is a phenomenon where a character's foot position, which is supposed to be fixed at a point, changes in character image frames in which the character's foot has to reach a predetermined ground. Accordingly, in order to clean up such “footskating” from character image frames in which a character's foot has to reach a predetermined ground, a process of fixing the character's foot position at a point is needed. Unlike motion-captured data, a character image frame that is received in real time gives no information about the next frame, that is, no information about the next position of a character's foot.

Accordingly, the constraint frame deciding unit 210 determines, when a character image frame is received, whether a character's foot included in the character image frame reaches a predetermined ground. The constraint frame deciding unit 210 sets a first character image frame in which a character's foot reaches the predetermined ground as a reference constraint frame, and designates the character's foot position in the reference constraint frame as a reference foot position.

Also, the constraint frame deciding unit 210 receives character image frames following the reference constraint frame, and extracts any constraint frames from among the received character image frames. A “constraint” frame means a character image frame in which a character's foot has to reach a predetermined ground, among received character image frames. In other words, a constraint frame means a character image frame to which an operation for cleaning up footskate is to be applied using the reference foot position acquired from the reference constraint frame.

The constraint frame deciding unit 210 may perform an operation for deciding (or detecting) the reference constraint frame in a sensor domain and a character domain.

The constraint frame deciding unit 210 may determine, in the sensor domain, whether a character's foot reaches a ground, using the position value of the character's foot in world coordinates received from the depth camera 120. Since the method is based on a position in a real space, the method may be sensitive to a user's location when the user is positioned in front of a sensor, the sensor's location, etc.

In the character domain, the constraint frame deciding unit 210 may determine whether a 3D character's foot reaches a predetermined ground defined in a virtual space, by mapping orientation values corresponding to a plurality of joints in a depth image frame to the corresponding joints of the 3D character to detect the position of the 3D character's foot and detecting the 3D character's position in the virtual space. Hereinafter, operation of detecting constraint frames in the character domain will be described.

If a character's foot position in a current character image frame is P_{f}, the character's foot position in the previous character image frame is P_{pF}, and a velocity at which the character's foot moves is V_{f}, the foot velocity V_{f} may be calculated by Equation 1, below.

V_{f}=r(P_{f}−P_{pf}/delta_{—}t,n), (1)

where r(v, n)=roundXL(v, n)=v rounded off to n digits. delta_t is a time interval between the character image frames.

The constraint frame deciding unit 210 determines whether the value of the foot velocity V_{F} and the value of the foot position P_{F} are smaller than predetermined threshold values, respectively, and detects, if the value of the foot velocity V_{f} and the value of the foot position P_{F} are smaller than predetermined threshold values, respectively, the corresponding character image frame as a constraint frame. That is, in character image frames detected as constraint frames, a velocity V_{f} at which a character's foot position changes is below the predetermined threshold value.

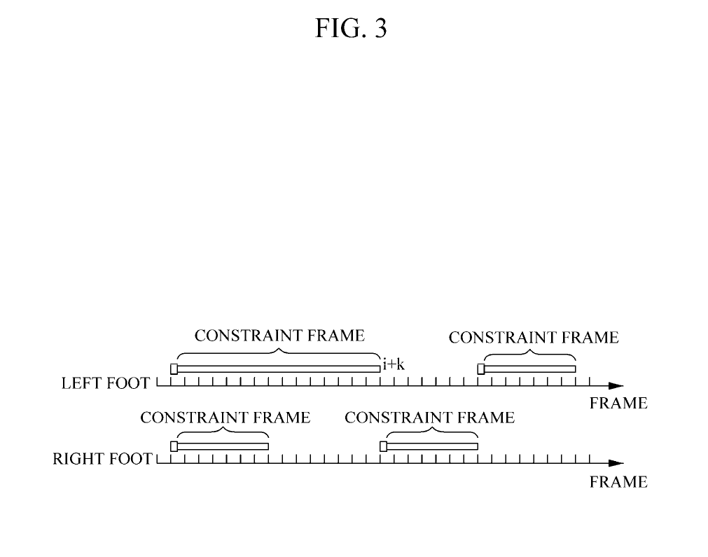

FIG. 3 shows an example of constraint frame periods in which a character's foot reaches a ground.

In FIG. 3, each gradation represents a character image frame. Constraint frames (or constraint frame periods) in which a character's foot has to reach a predetermined ground may be, as shown in FIG. 3, detected from among received character image frames.

Also, as shown in FIG. 3, constraint frames are detected separately for a left foot and a right foot. Accordingly, the constraint frame deciding unit 210 detects a reference constraint frame and constraint frames with respect to a character's left foot, and a reference constraint frame and constraint frames with respect to the character's right foot, simultaneously, from received character image frames.

Referring again to FIG. 2, the character posture adjusting unit 230 adjusts the posture of the character's lower body, based on the reference foot position, in the constraint frames received sequentially following the reference constraint frame, in which the character's foot has to reach the predetermined ground. Adjusting the posture of the character's lower body means adjusting the original orientation values of a plurality of joints in the character's lower body in the corresponding character image frame.

As shown in FIG. 2, the character posture adjusting unit 230 may include a root joint position adjusting unit 232, an Inverse Kinematics (IK) applying unit 234, and a smoothing unit 236.

In constraint frames or in character image frames belonging to constraint frame periods, there are cases where a character's foot does not reach a predetermined ground although the character is fully stretched. That is, there are cases where a character's foot is positioned above a predetermined ground in a virtual space although the character is fully stretched.

The root joint position adjusting unit 232 may determine whether or not a character's foot reaches a predetermined ground when the character is fully stretched. If the root joint position adjusting unit 232 may determine that a character's foot does not reach a predetermined ground although the character is fully stretched, the root joint position adjusting unit 232 processes the corresponding character image frame by changing the position of a root joint that decides a global position of the character such that a reference foot position of the character image frame reaches the predetermined ground. The root joint may be a torso center of joints. The reference foot position may include a reference foot position for the character's left foot and a reference foot position for the character's right foot.

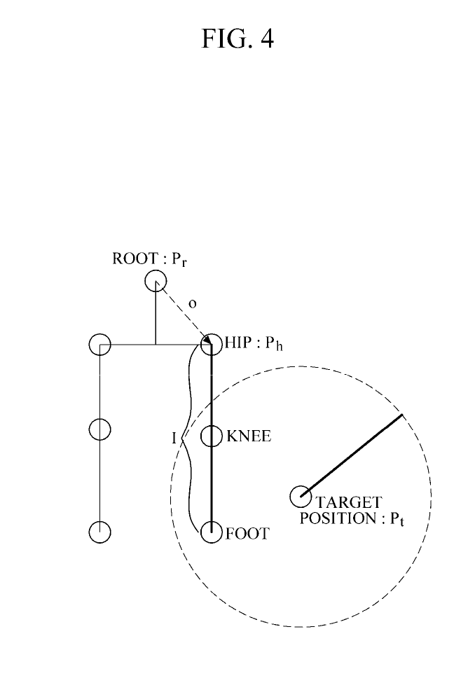

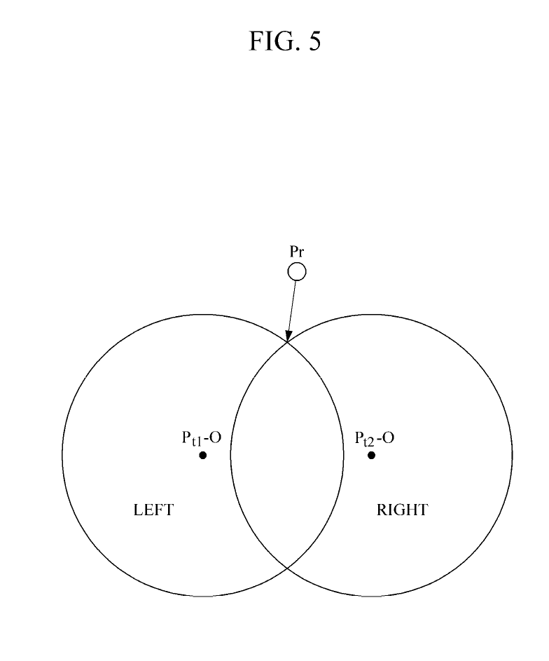

A method of changing the position of the root joint will be described with reference to FIGS. 4 and 5, below.

FIG. 4 is a view for explaining an example of a method of adjusting the position of a root joint based on a character's one leg.

In FIG. 4, Pᵣ represents the position of the root joint, Pₜ represents a reference foot position, o represents an offset vector at the root joint position Pᵣ, and l represents the length of the leg. The offset vector is the vector between the root joint and a hip joint. The hip joint is a joint from which the leg starts to appear.

In this case, the character's foot can reach the predetermined ground when the character is fully stretched, if the root joint position Pₜ satisfies a condition written as Equation 2, below.

∥Pt−Pr−o∥<1 (2)

According to the condition of Equation 2, by applying the offset vector o to the reference foot position Pₜ, a circle of radius 1 centered at a position Pt−o obtained by subtracting the offset vector o from the reference foot position Pt is drawn, and only when the root joint position Pᵣ is within the circle is it determined that the character's foot can reach the predetermined ground.

FIG. 5 is a view for explaining an example of a method of adjusting the position of a root joint based on a character's two legs.

In the example of FIG. 5, the character's two legs have to reach a predetermined ground.

Accordingly, if a reference left foot position is Pₜ₁ and a reference right foot position is Pₜ₂, the individual reference left and right foot positions Pₜ₁ and Pₜ₂ are applied to Equation 2 to draw two circles, and a root joint position Pᵣ of the corresponding character is adjusted to a point obtained by projecting the root joint position Pᵣ onto an area where the two circles overlap such that the root joint position Pᵣ can fall within the overlapping area of the two circles.

That is, the root joint position adjusting unit 232 may draw a first circle of radius 1 centered at a reference left foot position Pₜ₁ to which an offset vector o has been applied, and a second circle of radius 1 centered at a reference right foot position Pₜ₂ to which the offset vector o has been applied, decide one of intersections of the first and second circles as a new root joint position of the corresponding character of a constraint frame, and change the original root joint position of the character of the constraint frame to the new root joint position. If an original root joint position of a character of a constraint frame is adjusted to a new root joint position, the position in virtual space of the corresponding character is accordingly adjusted.

Then, an operation of adjusting the posture of a character's lower body will be described below.

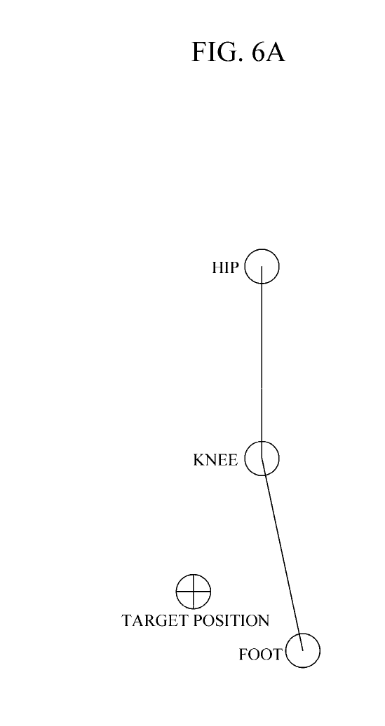

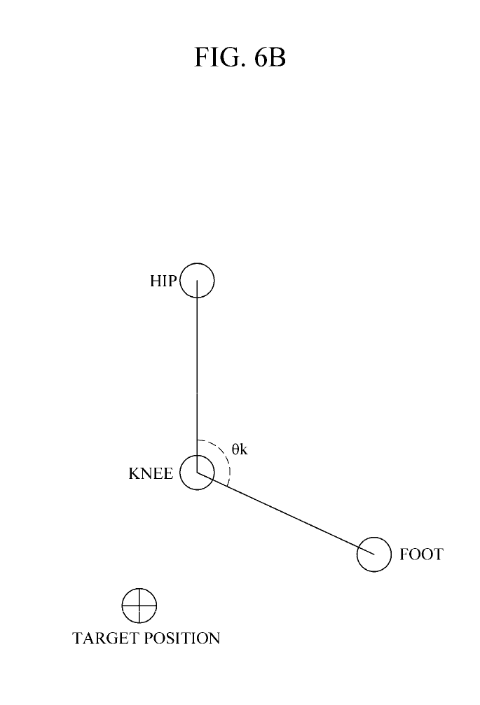

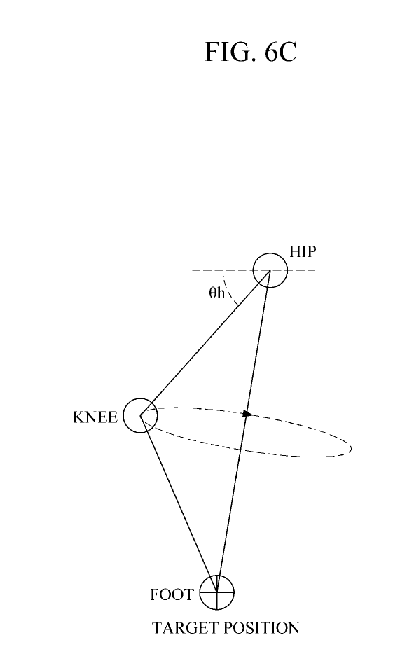

The IK applying unit 234 may apply an IK algorithm to constraint frames based on a reference foot position to thereby adjust the posture of a character's lower body. The IK algorithm is used to automatically calculate an amount of movement of the upper joint with a limited range according to movement of the lower joint. The operation of the IK applying unit 234 will be described with reference to FIGS. 6A, 6B, and 6C, below.

FIGS. 6A, 6B, and 6C are views for explaining an example where IK is applied to adjust a character's posture.

FIG. 6A shows a posture of a character's lower body, decided by adjusting a root joint. FIG. 6B shows the posture of the character's lower body adjusted by deciding the angle of the character's knee joint from the posture of the character's lower body shown in FIG. 6A. FIG. 6C shows the posture of the character's lower body adjusted by moving the character's foot position to a reference foot position in a state where the decided angle of the knee joint is maintained.

The IK applying unit 234 decides, if a reference foot position Pₜ is decided, the configuration of a leg, that is, orientation values of a hip joint, a knee joint, and an ankle joint, using a numerical solving method which will be described later. First, the IK applying unit 234 decides the angle of a character's knee joint. Generally, the angle of the knee joint is decided by calculating an IK solution.

If the vector between the hip joint position Pₕ and the reference foot position Pₜ which is a target position is Pₜ_{_{—}}Pₕ and the vector between the hip joint position Pₕ and the current position P_{f} of the character's foot is P_{f}_{_{—}}Pₕ, the IK applying unit 234 may obtain the angle θₖ of the knee joint by matching the two vectors in length.

The angle θₖ of the knee joint can be calculated by Equation 3, below.

$${θ}_{k} = arccos ( \frac{l {1}^{2} + l {2}^{2} + 2 \sqrt{l {1}^{2} - {\tilde{l 1}}^{2}} \sqrt{l {2}^{2} - {\tilde{l 2}}^{2}} f - ‖ {R}_{h} - {P}_{f} ‖}{2 \tilde{l 1} \tilde{l 2}} , \qquad ( 3 )$$

where l1 represents the length of the thigh, and l2 represents the length of the shin. sqrt(x) represents the square root of x. A knee is rotatable with respect to only one axis. Also, in Equation 3, [symbol] represents the length of the thigh when the thigh is projected onto a plane defined by the rotation axis of the knee, and [symbol] represents the length of the shin when the shin is projected onto the plane defined by the rotation axis of the knee.

Then, the IK applying unit 234 moves the character's foot position to the reference foot position Pₜ which is a target position in the state where the decided angle θₖ of the knee joint is maintained. In consideration of the hierarchical joints of a leg, which are arranged in the order of hip->knee->ankle, the IK applying unit 234 may calculate the angle θₕ of the hip joint which is the uppermost joint.

In summary, the IK applying unit 234 calculates the angle of a knee joint of a constraint frame such that the length of a first vector P_{f}_{_{—}}Pₕ between the position of a character's hip in the constraint frame and the current position of the character's foot is identical to the length of a second vector Pₜ_{_{—}}Pₕ between the position of the character's hip in the constraint frame and the reference foot position, and moves the current position of the character's foot to the reference foot position in the state where the calculated angle of the knee joint is maintained, to thereby calculate the angle of the character's hip joint in the constraint frame. Here, the current position of the character's foot is, when the position of the character's root joint is adjusted since the character's foot does not reach a predetermined reference foot position although the character's leg is fully stretched, a foot position adjusted in correspondence to adjustment in position of the root joint. If the position of the character's root joint is not adjusted, the current position of the character's foot is an original foot position set the corresponding character image frame is created.

There may be a plurality of angles θₕ for the hip joint, at which the character's foot position exactly reaches the reference foot position in the state where the angle θₖ of the knee joint is maintained, and the plurality of angles θₕ for the hip joint form a circle as denoted by a dotted line in FIG. 6C.

In this case, the IK applying unit 234 may select an angle closest to the original angle of the character's hip joint, from among the angles θₕ for the hip joint.

Since the operations of the depth image processor 210, the constraint frame deciding unit 220, the root joint position adjusting unit 232, and the IK applying unit 234 are performed on each of character image frames that are received in real time, there are cases where consistency between postures decided for the individual character image frames is not kept.

In order to keep consistency between postures decided for the individual character image frames, if the hip joint angle θₕ, knee joint angle θₖ, and ankle joint angle θₐ of a character of a constraint frame are compared to the hip joint angle θₕ, knee joint angle θₖ, and ankle joint angle θₐ in a character image frame received just before the constraint frame, respectively, and at least one of change values obtained from the comparison exceeds a predetermined threshold change angle set for the corresponding body part, the smoothing unit 246 (see FIG. 2) may perform smoothing on the constraint frame using the previous character image frame.

In this case, if the predetermined threshold change angle for hip joint angle θₕ is a first threshold change angle, the predetermined threshold change angle for knee joint angle θₖ is a second threshold change angle, and the predetermined threshold change angle for ankle joint angle θₐ is a third threshold change angle, the first, second, and third threshold change angles may be set to different values, respectively.

The smoothing unit 246 may perform smoothing on a current character image frame and the previous character image frame through a Spherical Linear Interpolation (SLERP) method.

The character image processing apparatus for footskate cleanup may be the character image processor of FIG. 2, or the character image processing apparatus of FIG. 1 that creates depth image frames, converts depth images into character images, and processes the character images.

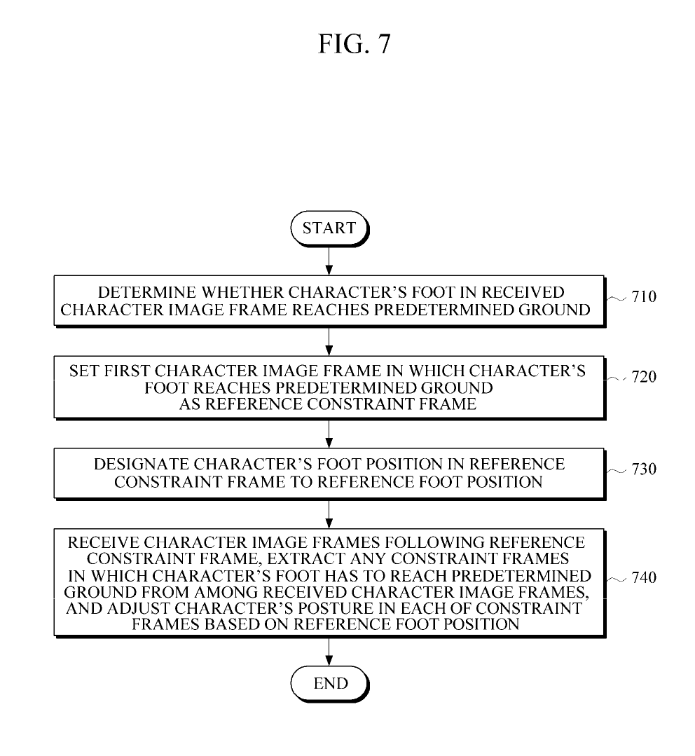

FIG. 7 is a flowchart illustrating an example of a character image processing method.

Referring to FIGS. 1 and 7, the character image processing apparatus 100 determines whether a character's foot in a received character image frame reaches a predetermined ground (710).

The character image processing apparatus 100 sets a first character image frame in which a character's foot reaches the predetermined ground as a reference constraint frame (720).

Also, the character image processing apparatus 100 designates the character's foot position in the reference constraint frame as a reference foot position (730).

Then, the character image processing apparatus 100 receives character image frames following the reference constraint frame, extracts any constraint frames in which the character's foot has to reach the predetermined ground from among the received character image frames, and adjusts the character's posture in each of the constraint frames based on a reference foot position (740).

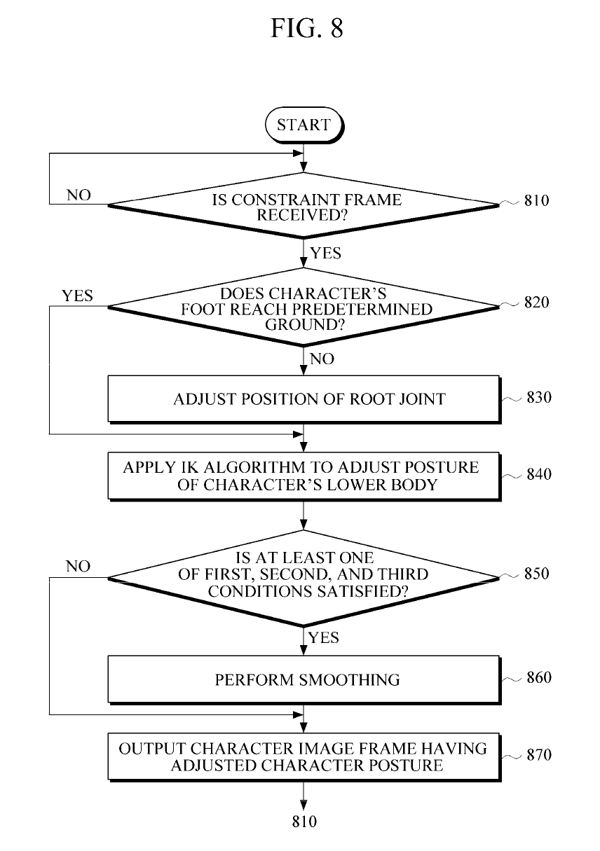

FIG. 8 is a flowchart illustrating in detail an example of the operation 740 of adjusting the character's posture.

First, it is determined whether a constraint frame is received (810).

If a constraint frame is received, the character posture adjusting unit 230 (see FIG. 2) determines whether the character's foot does not reach the predetermined ground although the character is fully stretched (820).

If the character's foot does not reach the predetermined ground although the character is fully stretched, the character posture adjusting unit 230 adjusts the position of a root joint of the character in the constraint frame such that the character's foot in the constraint frame reaches the predetermined ground (830). In operation 830, the character posture adjusting unit 230 may draw a first circle whose center is at a reference left foot position Pₜ₁ to which an offset vector has been applied and whose radius is a leg length l, and a second circle whose center is at a reference right foot position Pₜ₂ to which the offset vector has been applied and whose radius is the leg length l, decide one of intersections of the first and second circles as a new root joint position of the corresponding character of a constraint frame, and change the original root joint position of the character of the constraint frame to the new root joint position.

If the character's foot in the corresponding constraint frame reaches the predetermined ground when the character is fully stretched, the process proceeds to operation 840.

The character posture adjusting unit 230 applies the IK algorithm to the constraint frames based on the reference foot position to thereby adjust the posture of the character's lower body (840). In operation 840, the character posture adjusting unit 230 calculates the angle of a knee joint of each constraint frame such that the length of a first vector between the position of a character's hip in the constraint frame and the current position of the character's foot is identical to the length of a second vector between the position of the character's hip in the constraint frame and the reference foot position, and moves the current position of the character's foot to the reference foot position in the state where the calculated angle of the knee joint is maintained, to thereby calculate the angle of the hip joint of the character in the constraint frame. There may be a plurality of angles θₕ for the hip joint, at which the character's foot position exactly reaches the reference foot position in the state where the angle of the knee joint is maintained. In this case, the character posture adjusting unit 230 selects an angle closest to the original angle of the character's hip joint, from among the angles θₕ for the hip joint, thus secondarily deciding the angle of the character's hip joint in the constraint frame.

Then, the character posture adjusting unit 230 determines whether the constraint frame satisfies at least one of first, second, and third conditions (850). The first condition is the case where when the hip joint angle of a character of the constraint frame is compared to a hip joint angle in a character image frame received just before the constraint frame, a changed angle obtained as the result of the comparison exceeds a predetermined first threshold change angle. The second condition is the case where when the knee joint angle of the character of the constraint frame is compared to a knee joint angle in the previously received character image frame, a changed angle obtained as the result of the comparison exceeds a predetermined second threshold change angle. The third condition is the case where when the ankle joint angle of the character of the constraint frame is compared to an ankle joint angle in the previously received character image frame, a changed angle obtained as the result of the comparison exceeds a predetermined third threshold change angle.

If at least one of the first, second, and third conditions is satisfied, the character posture adjusting unit 230 performs smoothing on the constraint frame using the previously received character image frame to thereby readjust the posture of the character's lower body adjusted in operation 840 (860). Then, the character posture adjusting unit 230 outputs a character image frame having the posture of the character's lower body adjusted in operation 860 (870).

If none of the first, second, and third conditions is satisfied, the character posture adjusting unit 230 outputs a character image frame having the posture of the character's lower body adjusted in operation 840 (870). Then, the character posture adjusting unit 230 may perform operations described above on the following constraint frame.

Therefore, according to the example described above, it is possible to clean up footskate generated when real-time character animation is generated using a depth camera.

The present invention can be implemented as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as in Internet transmission. In addition, the computer-readable recording medium may be distributed to computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A character image processing apparatus comprising:
a constraint frame deciding unit configured to receive a character image frame, to determine whether a character's foot included in the character image frame reaches a predetermined ground, to set a first character image frame in which a character's foot reaches the predetermined ground as a reference constraint frame, and to designate the character's foot position in the reference constraint frame as a reference foot position; and
a character posture adjusting unit configured to extract any constraint frames in which the character's foot has to reach the predetermined ground from among character image frames received sequentially following the reference constraint frame, and to adjust a posture of the character in each constraint frame based on the reference foot position.

2. The character image processing apparatus of claim 1, wherein in the constraint frames, a velocity at which the character's foot position changes is below a predetermined threshold change value.

3. The character image processing apparatus of claim 1, wherein if the character's foot in each constraint frame does not reach the predetermined ground although the character is fully stretched, the character posture adjusting unit adjusts a posture of a root joint of the character in the constraint frame such that the character's foot in the constraint frame reaches the predetermined ground.

4. The character image processing apparatus of claim 1, wherein the reference foot position includes a reference left foot position and a reference right foot position, and
a character posture adjusting unit draws a first circle whose center is at a reference left foot position to which an offset vector representing a vector between a root joint and a hip joint has been applied and whose radius is a length of the character's leg, and a second circle whose center is at a reference right foot position to which the offset vector has been applied and whose radius is the length of the character's leg, decides one of intersections of the first and second circles as a new root joint position of the corresponding character of each constraint frame, and changes an original root joint position of the character of the constraint frame to the new root joint position.

5. The character image processing apparatus of claim 1, wherein the character posture adjusting unit applies an Inverse Kinematics (IK) algorithm to the constraint frames based on the reference foot position to thereby adjust a posture of the character's lower body.

6. The character image processing apparatus of claim 5, wherein the character posture adjusting unit calculates an angle of a character's knee joint of each constraint frame such that the length of a first vector between a position of the character's hip in the constraint frame and a current position of the character's foot is identical to the length of a second vector between the position of the character's hip in the constraint frame and the reference foot position, and moves the current position of the character's foot to the reference foot position in the state where the calculated angle of the character's knee joint is maintained, to thereby calculate an angle of the character's hip joint in the constraint frame.

7. The character image processing apparatus of claim 6, wherein if there are a plurality of angles for the character's hip joint, at which the character's foot position exactly reaches the reference foot position in the state where the calculated angle of the character's knee joint is maintained, the character posture adjusting unit selects an angle closest to an original angle of the character's hip joint from among the angles for the hip joint as the angle of the character's hip joint.

8. The character image processing apparatus of claim 5, wherein a hip joint angle, a knee joint angle, and an ankle joint angle of a character of each constraint frame are compared to a hip joint angle, a knee joint angle, and an ankle joint angle in a character image frame received just before the constraint frame, respectively, and if at least one of change values obtained from the comparison exceeds a predetermined threshold change angle set for the corresponding body part, the character posture adjusting unit performs smoothing on the constraint frame using the previous character image frame.

9. The character image processing apparatus of claim 1, further comprising a depth image processor configured to receive a depth image frame, to extract a plurality of joints from the depth image frame, to map the joints to a plurality of corresponding joints of a 3D character, to create a character image frame from the depth image frame, and to transfer the character image frame to the constraint frame deciding unit.

10. The character image processing apparatus of claim 1, further comprising:
an Infrared (IR) radiating unit configured to emit infrared radiation; and
a depth camera configured to capture reflected infrared radiation to create the depth image frame.

11. The character image processing apparatus of claim 1, further comprising a display configured to provide real-time character animation by sequentially displaying character images each having an adjusted posture of a character.

12. A character image processing method comprising:
receiving a character image frame and determining whether a character's foot included in the character image frame reaches a predetermined ground;
setting a first character image frame in which the character's foot reaches the predetermined ground as a reference constraint frame;
designating the character's foot position in the reference constraint frame as a reference foot position; and
extracting any constraint frames in which the character's foot has to reach the predetermined ground from among character image frames received sequentially following the reference constraint frame, and adjusting a posture of the character in each constraint frame based on the reference foot position.

13. The character image processing method of claim 12, wherein the adjusting of the posture of the character based on the reference foot position comprises:
determining whether the character's foot in each constraint frame reaches the predetermined ground when the character is fully stretched; and
adjusting, if the character's foot in the constraint frame does not reach the predetermined ground when the character is fully stretched, a posture of a root joint of the character in the constraint frame such that the character's foot in the constraint frame reaches the predetermined ground.

14. The character image processing method of claim 13, wherein the reference foot position includes a reference left foot position and a reference right foot position, and
the adjusting of the posture of the root joint of the character in the constraint frame comprises:
drawing a first circle whose center is at a reference left foot position to which an offset vector representing a vector between a root joint and a hip joint has been applied and whose radius is a length of the character's leg, and a second circle whose center is at a reference right foot position to which the offset vector has been applied and whose radius is the length of the character's leg, and deciding one of intersections of the first and second circles as a new root joint position of the corresponding character of a constraint frame; and
changing an original root joint position of the character of the constraint frame to the new root joint position.

15. The character image processing method of claim 13, wherein the adjusting of the posture of the character further comprises applying, after adjusting the posture of the root joint of the character in the constraint frame, an Inverse Kinematics (IK) algorithm to the constraint frames based on the reference foot position to thereby adjust a posture of the character's lower body.

16. The character image processing method of claim 15, wherein the applying of the IK algorithm to the constraint frames based on the reference foot position to thereby adjust the posture of the character's lower body comprises:
calculating an angle of the character's knee joint of each constraint frame such that the length of a first vector between a position of the character's hip in the constraint frame and a current position of the character's foot is identical to the length of a second vector between the position of the character's hip in the constraint frame and the reference foot position; and
moving the current position of the character's foot to the reference foot position in the state where the calculated angle of the character's knee joint is maintained, to thereby calculate an angle of the character's hip joint in the constraint frame.

17. The character image processing method of claim 16, wherein in the moving of the current position of the character's foot to the reference foot position in the state where the calculated angle of the character's knee joint is maintained to thereby calculate the angle of the character's hip joint in the constraint frame,
if there are a plurality of angles for the character's hip joint, at which the character's foot position exactly reaches the reference foot position in the state where the calculated angle of the character's knee joint is maintained, an angle closest to an original angle of the character's hip joint, from among the angles of the hip joint is selected as the angle of the character's hip joint.

18. The character image processing method of claim 15, after adjusting the posture of the character's lower body, further comprising comparing a hip joint angle, a knee joint angle, and an ankle joint angle of a character of each constraint frame, to a hip joint angle, a knee joint angle, and an ankle joint angle in a character image frame received just before the constraint frame, respectively, and performing, if at least one of change values obtained from the comparison exceeds a predetermined threshold change angle set for the corresponding body part, smoothing on the constraint frame using the previous character image frame.

19. The character image processing method of claim 12, further comprising mapping a plurality of joints of a depth image frame obtained by photographing a real environment to a plurality of corresponding joints of a 3D character, and creating the character image frame from the depth image frame.
